(19) United States
(12) Patent Application Publication
(10) Pub. No.: US 2023/0044708 A1
(43) Pub. Date: Feb. 9, 2023

(54) ANTI-CONSTIPATION AND ANTI-FLATULENCE DEVICE

(71) Applicants: Andrea CALAMITA, Sestri Levante (GE) (IT); Roberto POLLATO, Milano (MI) (IT); Lorenzo MORI, Genova (GE) (IT); AEFFE SAS DI F. GRASSO & C., Genova(GE) (IT)

(72) Inventors: Andrea CALAMITA, Sestri Levante (GE) (IT); Roberto POLLATO, Milano (MI) (IT); Lorenzo MORI, Genova (GE) (IT)

(21) Appl. No.: 17/792,622

(22) PCT Filed: Jan. 12, 2021
(86) PCT No.: PCT/IB2021/050190

§ 371 Date: Jul. 13, 2022

(30) Foreign Application Priority Data
Jan. 13, 2020 (IT) 102020000000463

(51) Int. Cl. A61H 7/00

(52) U.S. Cl. CPC A61H 7/005; A61H 2201/1666; A61H 2201/149; A61H 2201/0192; A61H 2205/083

(57) ABSTRACT

Anti-constipation and anti-flatulence device is provided which comprises an outer casing, inside which outer casing is movably mounted at least one piston having at one end a support foot on a patient's belly. Movement means of said piston are further present, configured such that the piston passes from a condition of maximum extraction from the outer casing of the support foot to a condition of minimum extraction and/or insertion of the support foot and vice versa and such that, in the maximum extraction condition, the support foot translates linearly along a work plane, which work plane substantially identifies the patient's belly.

The present invention relates to an anti-constipation and anti-flatulence device.

Constipation is a pathological condition of costiveness, basically linked to an intestinal motility disorder, which causes defecation disorders consisting in the difficulty of expelling faeces, not allowing the emptying of all or part of the intestine.

Such a disorder has been strongly growing in recent years, and currently affects about 9% of children and 12-19% of adults, with a high percentage in adult female subjects and elderly adults.

In the state of the art there are several remedies, which however have disadvantages and are not always decisive.

They range from traditional remedies involving the purchase of laxatives, the stimulation of the rectal ampulla through the use of bulbs, suppositories or enemas, to natural remedies involving the use of mixtures of water and fibre, the change of defecating habits or hydrocolontherapy.

The remedies just described have the advantage of being non-invasive, however they are hardly effective, especially the natural remedies, or require continuous costs, such as the periodic purchase of laxatives.

On the other hand, invasive remedies, such as surgical treatments, are temporarily decisive, but present risks related to post-operative complications and outcomes.

Therefore, the best solution at the moment, i.e., the most effective one which solves the disadvantages of the remedies just described, is colic massage.

Such a massage has already been known since the end of the 19th century and uses techniques which apply constant compression along the colic frame clockwise from right to left, in order to improve the rhythm and quality of evacuations.

Unlike the remedies known in the state of the art, colic massage does not cause addiction and does not cause any harm to the patient and also has a rehabilitative function.

However, colic massage is contraindicated for pregnant women, for those with abdominal wall hernias and for patients with neoplasms at high risk of bleeding.

In addition to these problems, the main disadvantage of colic massage is that it requires the constant presence of an external operator who can perform the massage on patients.

The need for an external operator does not simply pose a problem related to the presence of the operator himself, but it is evident that the massage cannot be repeated in a systematic, standardized and reproducible manner.

It is also possible to practice colic self-massage, however this technique requires particular experience and is therefore ineffective, especially considering that constipation often affects the elderly, disabled or sick in bed.

There is therefore a need which is not satisfied by the state of the art to provide a device which allows to overcome the above-described disadvantages.

The present invention achieves the above objects by creating an anti-constipation device comprising an outer casing, inside which at least one piston is movably mounted which has at one end a support foot on the belly of a patient.

Movement means of the piston are also present, configured such that said piston passes from a condition of maximum extraction from the outer casing of the support foot to a condition of minimum extraction and/or insertion of the support foot and vice versa and such that, in a maximum extraction condition, the support foot linearly translates along a work plane, which work plane substantially identifies the belly, or rather one or more of the three final sections of the patient's colon.

The invention therefore has the object of obtaining a simple device which automatically reproduces the colic massage and, as will be evident from the use method described below, which helps faeces move towards the natural direction thereof.

It will also be evident how the device can be used comfortably and autonomously by all subjects who have more or less serious constipation problems.

Compared to the colic massage performed by a professional, in addition to the obvious economic savings, the device object of the present invention allows to effectively perform the massage at any time of day and in privacy, avoiding the embarrassment of sharing noises and odours of one's intestines.

As will be described below, with regard to the use method of the device object of the present invention, in order to obtain a colic massage performed automatically and objectively, i.e., not dependent on external operators, the translation of the support foot on the patient's colon sections must be repeated for several cycles and at different points of the patient's colon sections.

For this reason, according to a preferred embodiment, the movement means are configured such that the support foot, in a minimum extraction condition, translates linearly along a rest plane parallel to the work plane.

Therefore, the obtained movement of the piston and the relative support foot is preferably a repeated and continuous movement along a perpendicular trajectory, consisting of two translations parallel to the work plane and two translations perpendicular to the work plane.

Such a trajectory can be obtained through any embodiment of the movement means known in the state of the art.

According to a preferred embodiment, the movement means comprise a rack cooperating with a pinion.

The rack is integral and mounted inside the outer casing and arranged on a plane perpendicular to the work plane, such that the rack identifies a closed path with at least one side parallel to the work plane, the pinion being integral with said piston.

According to an improvement, the support foot has a support face facing in the direction of the work plane and oriented along a plane indicating the work plane.

The inclination of the support foot allows to optimize the pushing action of the faeces during the translation of the piston along the patient's belly, in the maximum extraction condition of the support foot.

Advantageously, said support face has a plurality of ribs oriented in a direction perpendicular to the direction of translation of the support foot, shaped so as to simulate the fingers of a closed fist.

It is evident how such a configuration allows to best simulate the colic massage carried out by the first of an operator, such that the device object of the present invention combines the advantages of manual operators, such as care and effectiveness in the execution of the massage, with the advantages of automatic devices, such as objectivity and repeatability.

In order to obtain a high adaptability of the device object of the present invention, according to a possible embodiment weight adjustment means of the device are included.

Such adjustment means can be obtained for example through independent elements, such as metal weights or the like, which can be inserted inside the outer casing of the device and fastened to the walls thereof.

To fasten such metal weights, special fastening means or seats for housing the weights themselves inside the outer casing can be included.

The possibility of varying the weight of the device has a particularly advantageous aspect in that it is possible to adapt the operation of the device according to the patient's body fat, in that a greater weight generates greater pressure on the patient's belly and allows the support foot to act correctly on the patient's colon without being affected by the patient's layer of body fat.

Another possible measure to adapt the device object of the present invention to the shape of the patient's body is the possibility of adjusting the overall height of the device, either by modifying the dimensions of the outer casing, preferable solution, or by means of piston length adjustment means.

For example, a piston with a telescopic stem can be provided. A possible embodiment will be described below, through the use of some exemplary embodiments.

According to a possible embodiment, the outer casing comprises at least two gripping handles.

The advantages of such a configuration are evident and allow to improve the grip of the patient on the device, who can therefore use it independently.

Still with the object of making the device easier to use and more comfortable for patients, the outer casing has a face facing the direction of the work plane, which in turn has one or more cushioning support elements.

Therefore, the face which comes into contact with the patient's belly has a kind of soft pad supporting on the patient's belly, without the material forming the outer casing bothering the patient during the execution of the massage.

Having seen the advantageous aspects so far described related to the anti-constipation device, the present invention also relates to a use method of such a device.

The method involves the following steps:
a) positioning the device on a patient's belly such that the direction of translation of the support foot is positioned along a first working line, aligned along the longitudinal axis of a patient in a head-foot direction, at the first section of the colon,
b) positioning the support foot in a maximum extraction condition,
c) translating the support foot along the working line, in a head-foot direction,
d) positioning the support foot in a minimum extraction condition,
e) translating the support foot in the opposite direction with respect to step b),
f) positioning the device on the patient's belly such that the direction of translation of the support foot is positioned along a second working line, aligned along the front plane of a patient in a right-left direction, at the second colon section,
g) repeating steps b) to e), the translation of said support foot being carried out in the right-left direction,
h) positioning the device on the patient's belly such that the direction of translation of the support foot is positioned along a third working line, aligned along the longitudinal axis of a patient in a head-foot direction, at the third colon section,
i) repeating steps b) to e), the translation of the support foot being carried out in the head-foot direction.

The object of such a method is therefore to obtain an automatic and repeatable colic massage, aimed at pushing the faeces along the colon and helping the expulsion thereof.

It follows that compared to colic self-massage, the device and method object of the present invention have the obvious advantage of not requiring any particular effort or skill: anyone, especially elderly and/or disabled patients, can lie comfortably, rest the device on the abdomen and follow the steps of the method described above, even repeating them a desired number of times.

These and other features and advantages of the present invention will become clearer from the following description of some exemplary embodiments illustrated in the attached drawings in which:

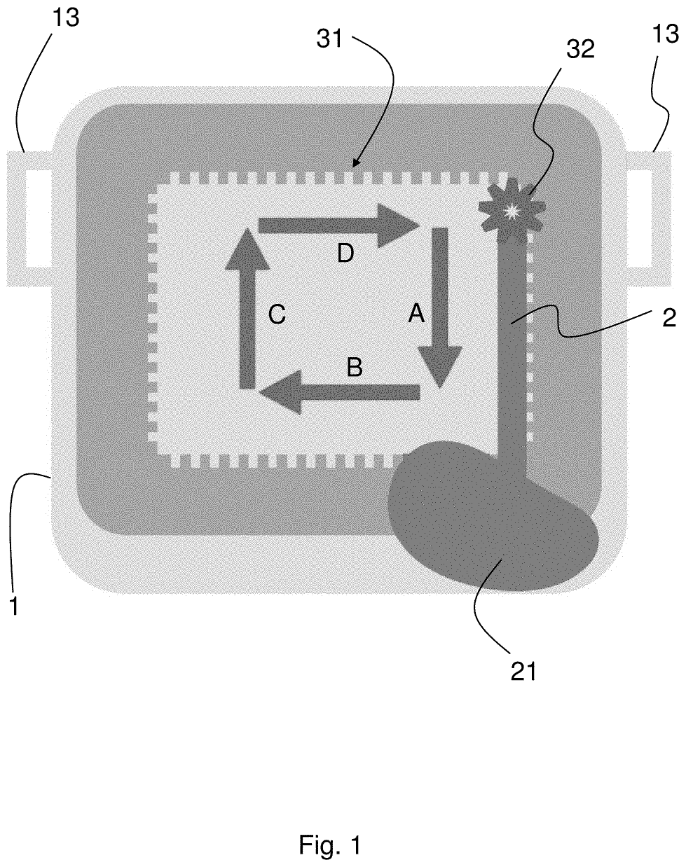

FIG. 1 illustrates a view of a preferred variant embodiment of the anti-constipation device object of the present invention;

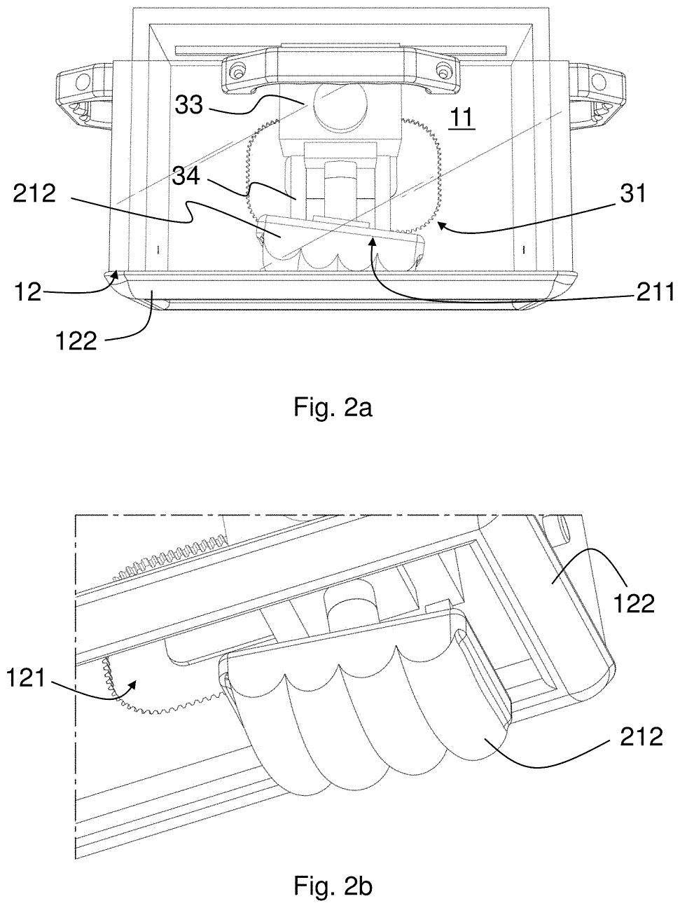

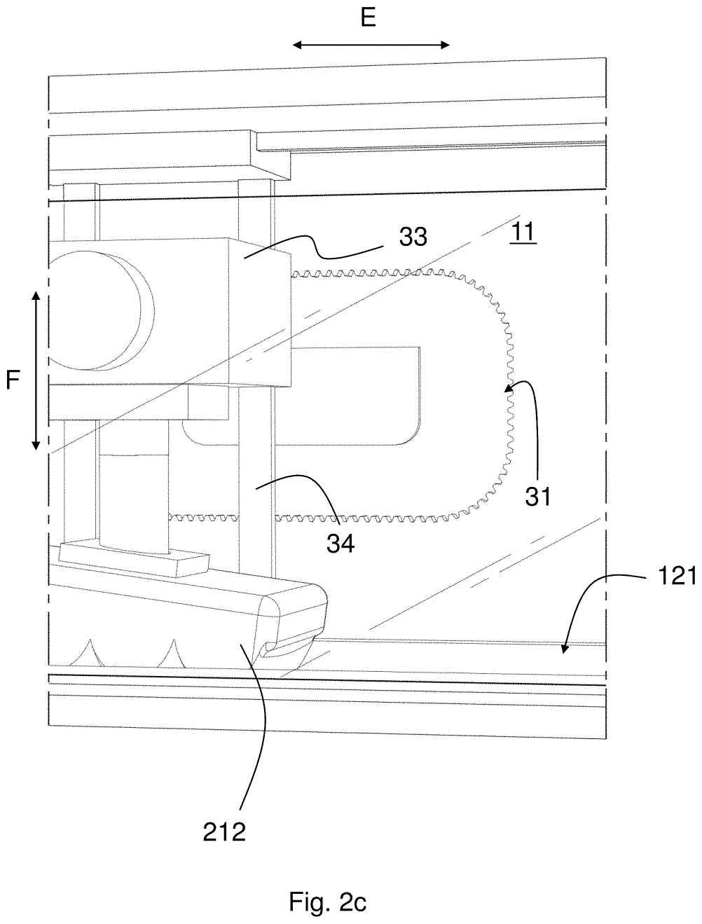

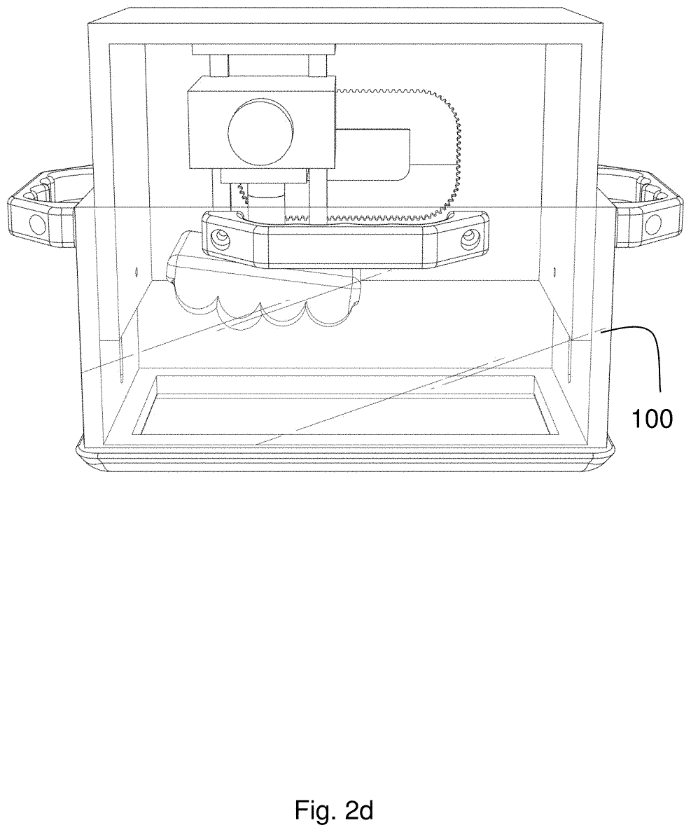

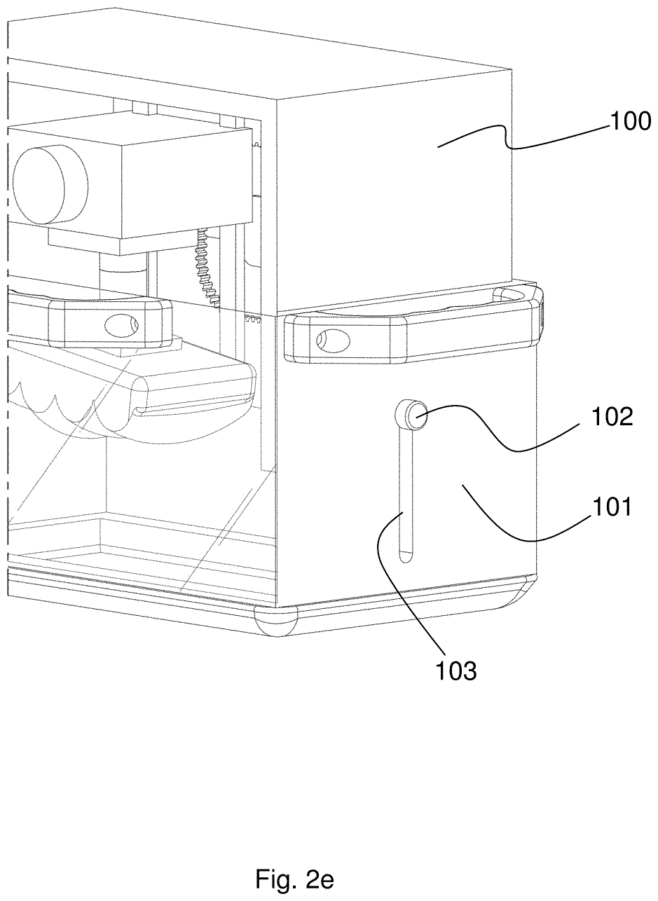

FIGS. 2a-2e illustrate some details of the variant embodiment illustrated in FIG. 1;

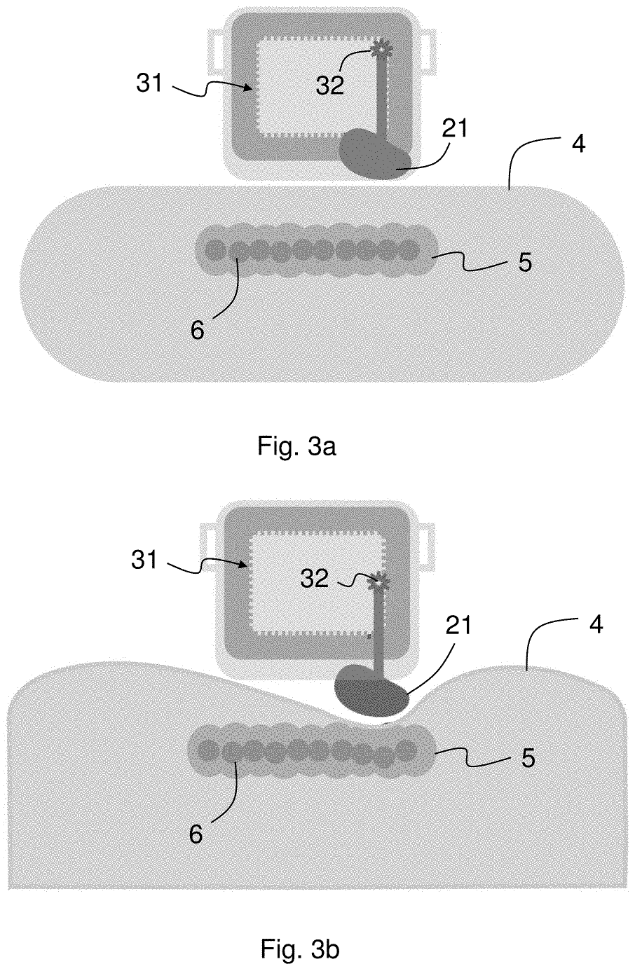

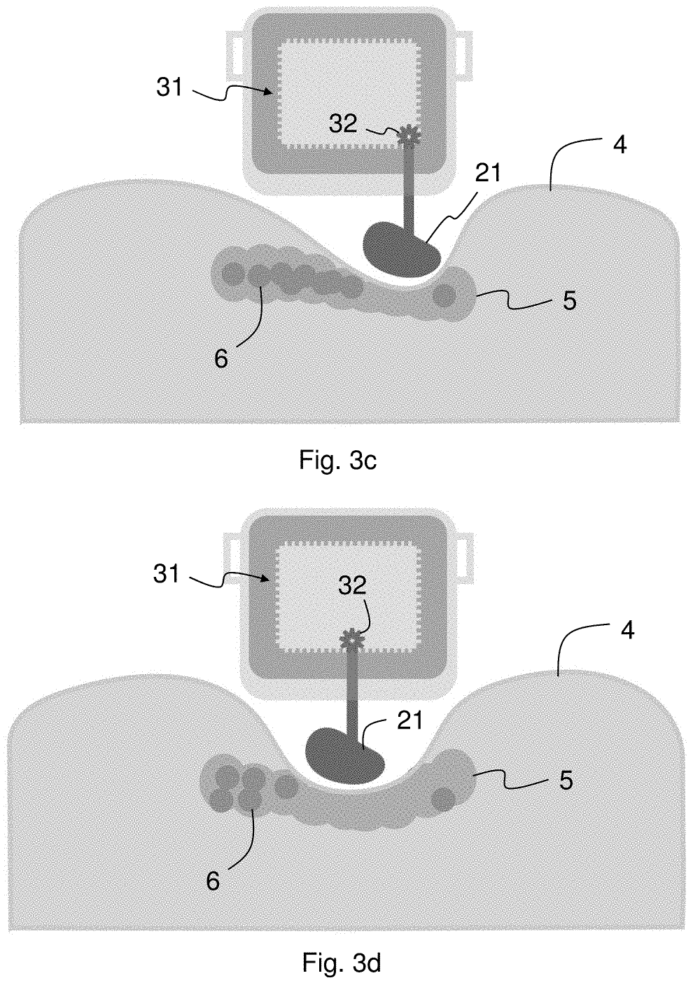

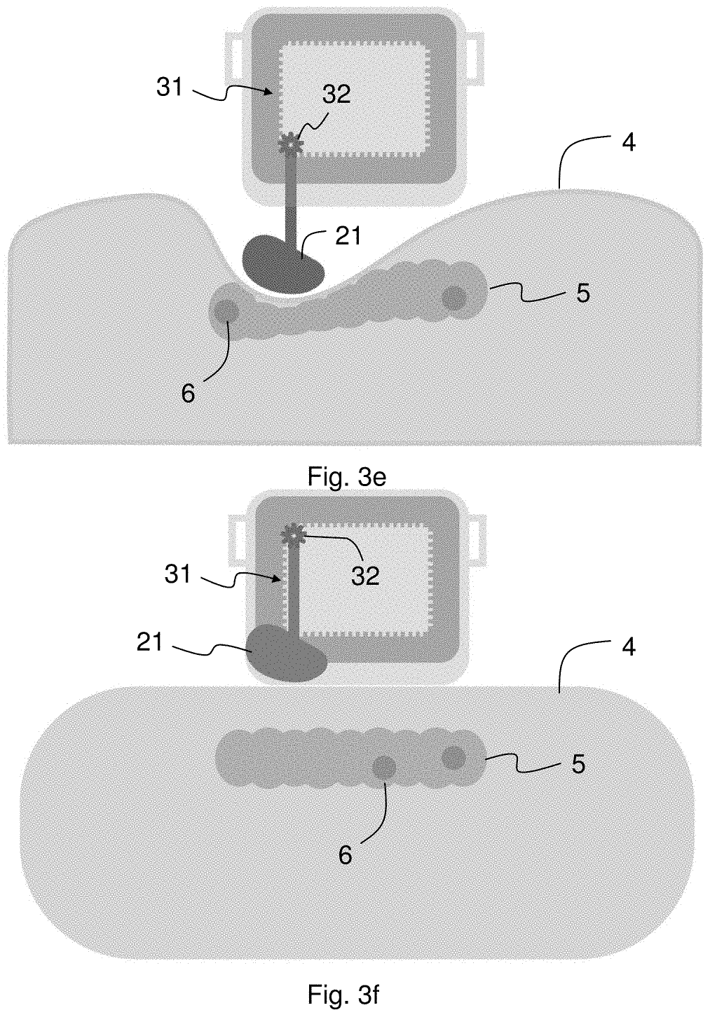

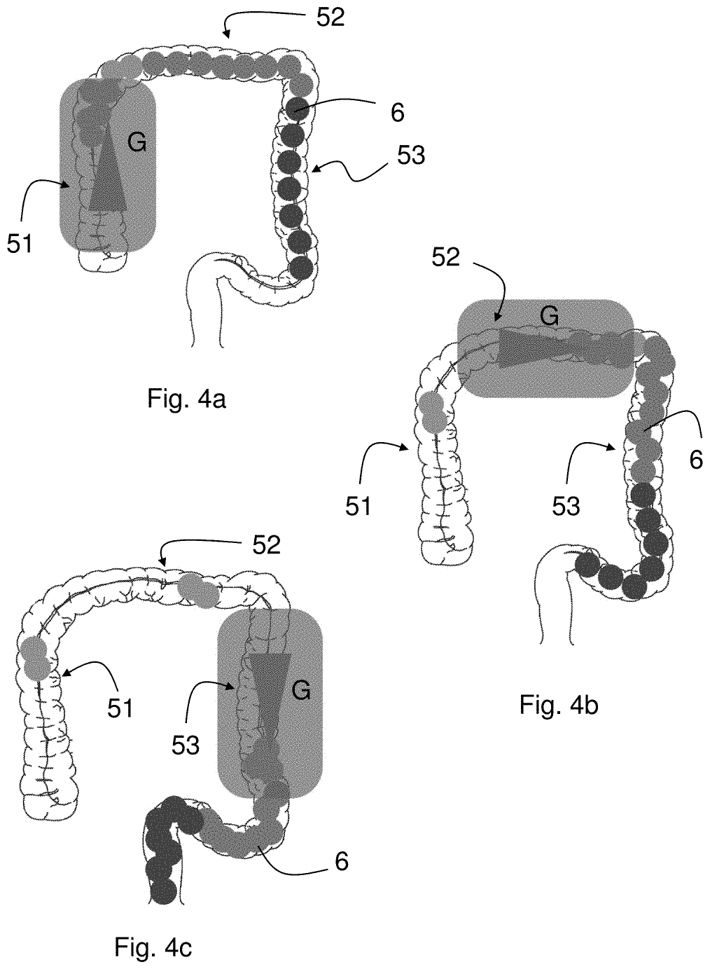

FIGS. 3a to 4c illustrate some views aimed at showing the use methodology of the anti-constipation device object of the present invention.

It should be noted that the embodiments shown in the figures attached to the present application are shown to better understand the advantages and features of the device claimed below.

Such embodiments are therefore to be understood for illustrative purposes only and not limited to the inventive concept of the present invention, namely, to obtain an anti-constipation device which allows to automate the colic massage procedure, making the execution of such a massage independent of the operator, effective and repeatable.

With particular reference to FIG. 1, the anti-constipation device object of the present invention comprises an outer casing 1, inside which a piston 2 is movably mounted which has at one end a support foot 21 on the belly of a patient.

In FIG. 1, the outer casing 1 is illustrated in a parallelepiped form, but it is obviously possible to obtain it in any shape known to the state of the art, which allows an easy use of the device object of the present invention.

The device object of the present invention further comprises means for moving the piston 2, which activate the piston 2 according to the methods illustrated in FIGS. 3a to 3f.

In particular, the movement means are configured such that the support foot 21 switches from a condition of minimum extraction from the outer casing 1, FIGS. 1, 3a and 3f, to a condition of maximum extraction from the outer casing 1, FIGS. 3c, 3d and 3e.

The minimum extraction condition can be related to both a minimum extraction condition of the support foot 21 from the outer casing 1, and to a condition of insertion of the support foot 21 inside the outer casing 1.

The support foot 21 is minimally extracted from or inserted into the outer casing 1, depending on the length of the piston 2.

According to the variant shown in the figures, the movement means comprise a rack 31 and a pinion 32 sliding along the rack 31.

The rack 31 is integral with the outer casing 1, while the pinion 32 is integral with the piston 2, so that the piston 2 and the support foot 21 make a rectangular path, identified by the arrows A, B, C and D.

In particular, the support foot 21 moves along a vertical axis in the direction of the arrow A, passing from the minimum extraction condition to the maximum extraction condition.

Once in the maximum extraction condition, the support foot 21 maintains such a condition by linearly translating along a vertical axis in the direction of the arrow B.

During the maximum extraction condition, as will be described later with regard to FIGS. 3a to 3f, the support foot 21 identifies a work plane, i.e., the points of contact between the lower surface of the support foot 21 and the patient's belly 4.

At the end of the section of the rack 31 along the direction of the arrow B, the pinion 32 is in the lower left corner.

Starting from such a condition, the pinion 32, and consequently the support foot 21, moves along the rack 31 along the direction of the arrow C, passing from the maximum extraction condition to the minimum extraction condition.

Maintaining the minimum extraction condition, the pinion 32 and the support foot 21 move horizontally along the rack 31 in the direction D.

As will be evident from the following description, since along the section D of the rack 31, the support foot does not actively work, i.e., it is not in contact with the patient's belly 4, it can move faster with respect to the section B of the rack 31.

For example, the use of a two-speed motor could be included.

FIGS. 2a to 2e illustrate some details of the device object of the present invention.

In particular, as anticipated, the outer casing 1 consists of a parallelepiped container which therefore has four side walls 11, a bottom wall 12 and a top wall.

The bottom wall 12 has a slot 121 to allow the extraction of the support foot 21 and the sliding of the piston 2.

Advantageously, according to the variant illustrated in FIGS. 2a and 2c, the rack 31 is provided on one of the four side walls 10.

As illustrated, the rack 31 is formed inside the thickness of the side wall 11.

The pinion 32 included at the end of the piston 2 opposite the end of the support foot 21 slides on the rack 31.

The movement means further comprise a slide 33 and a track 34.

The track 34 is translatably fastened to the side wall 10, so that during the path made by the pinion 32 along the rack 31, it moves along the direction of the arrow E.

The slide 33 is instead integrally fastened to the piston 2, such that during the path made by the pinion 32 along the rack 31, it moves along the direction of the arrow F.

The activation of the movement means can be carried out in any manner known in the state of the art.

For example, the slide 33 may comprise an electric motor, powered by a battery, which moves the slide 33 itself and the corresponding pinion 32 and piston 2.

According to one embodiment, two racks 31 positioned opposite each other can be included at two opposite side walls.

A piston 32 slides on each rack 31 so as to reproduce the operation described above.

In this case, the piston 2 is integral with the two pinions 32 and connected thereto through a fastening pin, according to the methods known in the state of the art.

Thereby, the piston 2 would have two points of contact with the outer casing 1 and is more stable during the movement thereof, since it discharges the weight thereof at two points opposite each other, with respect to the longitudinal axis of the piston 2.

According to a possible embodiment, the movement means, comprising at least the rack 31, the pinion 32, the slide 33 and the track 34, can be integrated inside a single component, connectable to the outer casing 1 and/or to the piston 2.

Such a component can also integrate the piston 2, or can be fastened to the piston 2.

In this case, the device object of the present invention therefore provides an easily assemblable, mountable and removable component which encloses the entire movement part of the piston 2.

Such a component can be fixed to the outer casing 1, which comprises a bottom wall 12 obtained in a manner entirely similar to that previously described.

The component which integrates the movement means can therefore be provided in combination with an outer casing and/or a piston having one or more of the features described above.

The bottom wall 12 identifies the support surface of the device on the patient's belly 4.

Such a support surface, as shown in FIG. 2b, can have a cushioning element 122, consisting of an element of elastically deformable and yielding material, aimed at making the support of the device on the patient's belly more comfortable.

For obvious hygiene reasons, the cushioning element 122 can be detachably fastened to the bottom wall 12, for example through the use of fastening means such as Velcro® or the like.

According to the variant illustrated in the figures, the support foot 21 consists of a plate 211, a support element 212 is fastened to such plate 211.

The plate 211 is inclined so as to present a lower edge and an upper edge, such that the plate 211 is inclined so as to present the lower edge positioned to the right with respect to the upper edge, with reference to the figures.

Thereby, the plate 211 has an inclination facing in the direction of the pushing direction, i.e., in the direction of the arrow D of FIG. 1.

The support element 212 instead has four ribs, with the longitudinal axis thereof facing perpendicular with respect to the translation of the piston 2, configured to simulate the fingers of a closed fist, as shown in FIG. 2b.

In order to improve the friction of the support foot 21 with the customer's belly, a lubricant can be provided interposed between the support foot 21 and the belly.

The support element 212 can therefore have special deposits of such lubricant, so as to release such lubricant during the use of the device object of the present invention.

Finally, the outer casing 1 has four gripping handles 13 which allow the device object of the present invention to be pressed against the patient's belly 4.

The handles 13 are arranged so as to lie on a plane parallel to the bottom wall 12, so as to facilitate the grip of a patient lying down.

As anticipated, in order to adapt the device object of the present invention to the various types of patients, adjustment means of the size of the device itself can be provided.

FIGS. 2d and 2e illustrate a possible embodiment, in which the variation in size is related to a variation in the height of the device, obtained through a peculiar configuration of the outer casing 1.

In fact, the outer casing 1 is formed by two parts 100 and 101, of which an upper part 100 and a lower part 101.

The two parts are shaped such that the part 101 can be contained inside the part 100 and slide therein, direction E of FIG. 2e, to adjust the height of the device.

In particular, in FIG. 2d the device has a minimum height condition, while in FIG. 2e the device has a maximum height condition.

The extraction of the part 101 with respect to the part 100 can be adjusted and fastened by means of special fastening screws 102, which cooperate with corresponding guides 103 included on the part 100 and on the part 101.

FIGS. 3a to 3f illustrate the use of the device object of the present invention, which allows to push the faeces 6 present inside a patient's colon 5 from an initial section of the colon, FIG. 4a, to a final section of the colon, FIG. 4c, to facilitate the extraction thereof from the colon 5 itself.

FIGS. 3a to 3f refer in particular to a procedure performed on a section of the colon, a procedure which can be repeated, as will be described later, for all the sections of the colon.

In FIG. 3a the support foot 21 is in the minimal extraction condition, the pinion 32 is located at the top right of the rack 31 and the support foot is not in contact with the patient's belly 4.

The pinion 32 begins the descent downwards along the rack 31, the support foot 21 descends and contacts the patient's belly 4, deforming it, FIG. 3b.

In FIG. 3c the pinion 32 has finished the downwards stroke thereof, the support foot 21 is in the maximum extraction condition and deforms the colon 5 so as to predispose the faeces 6 for pushing.

In the maximum extraction condition, the support foot 21 begins to translate to the left, FIG. 3d, and pushes the faeces 6 to the left, with reference to FIGS. 3a-3f, up to an end area of the colon section 5 of interest, FIG. 3e.

In FIG. 3e the pinion 32 has run entirely along the lower portion of the rack 31 until it reaches the lower left corner of the rack 31.

Once the translation of the pinion 32 along the lowest section of the rack 31 with the support foot 21 in the maximum extraction condition is finished, the support foot 21 returns to the minimum extraction condition, FIG. 3f.

As illustrated in FIG. 3f, a single translation of the support foot 21 in the maximum extraction condition may not be sufficient to obtain the displacement of the entire amount of faeces 6 inside the colon 5.

For this reason, the procedure just described, related to FIGS. 3a to 3f, can be repeated any number of times.

Based on the experimental studies and patient results, a number between 3 and 5 repetitions is optimal.

As anticipated, the procedure described and related to FIGS. 3a/3f is not only repeated any number of times for the same section of the colon 5, but for different sections of the colon 5.

FIGS. 4a to 4c illustrate such a concept: the colon 5 has an initial section 51, an intermediate section 52 and an end section 53.

In FIG. 4a, the device object of the present invention is positioned on the initial section 51 of the colon 5, so that the support foot 21 translates in the maximum extraction condition in the direction indicated by the arrow G.

The faeces 6 are thus pushed towards the intermediate section 52 of the colon 5.

In FIG. 4b, the device object of the present invention is positioned on the intermediate section 52 of the colon 5, so that the support foot 21 translates in the maximum extraction condition in the direction indicated by the arrow G.

The faeces 6 are thus pushed towards the end section 53 of the colon 5.

In FIG. 4c, the device object of the present invention is positioned on the end section 53 of the colon 5, so that the support foot 21 translates in the maximum extraction condition in the direction indicated by the arrow G.

The procedure just described thus allows the accumulation of faeces 6 in the end section 53 of the colon, so as to facilitate the expulsion thereof outside the colon 5.

While the invention is susceptible to various modifications and alternative constructions, some preferred embodiments have been shown in the drawings and described in detail.

It should be understood, however, that there is no intention of limiting the invention to the specific illustrated embodiment but, on the contrary, it aims to cover all the modifications, alternative constructions, and equivalents falling within the scope of the invention as defined in the claims.

The use of “for example”, “etc.”, “or” refers to non-exclusive non-limiting alternatives, unless otherwise stated.

The use of “includes” means “includes but not limited to”, unless otherwise stated.

1-10. (canceled)

11. An anti-constipation and anti-flatulence device, the device comprising:
an outer casing, inside which outer casing is movably mounted at least one piston having at one end a support foot on a patient's belly,
movement means of said piston being present, configured such that said piston passes from a condition of maximum extraction from the outer casing of the support foot to a condition of minimum extraction and/or insertion of the support foot and vice versa and such that, in the maximum extraction condition, said support foot translates linearly along a work plane, which work plane substantially identifies the patient's belly.

12. The device according to claim 11, wherein said movement means are configured such that said support foot, in the minimum extraction condition, not in contact with the patient's belly, translates linearly along a rest plane parallel to the work plane.

13. The device according to claim 11, wherein said movement means comprise a rack cooperating with a pinion,
said rack being integral with and mounted inside the outer casing and arranged on a plane perpendicular to said work plane,
said rack identifying a closed path with at least one side parallel to said work plane,
said pinion being integral with said piston.

14. The device according to claim 11, wherein said support foot has a support face facing in the direction of the work plane and oriented along a plane indicating said work plane.

15. The device according to claim 14, wherein said support face has a plurality of ribs oriented in a direction perpendicular to the direction of translation of said support foot, shaped so as to simulate the fingers of a closed fist.

16. The device according to claim 11, wherein means for adjusting the weight of said device are included.

17. The device according to claim 11, wherein means for adjusting the size of the device itself are included.

18. The device according to claim 11, wherein the outer casing comprises at least two gripping handles.

19. The device according to claim 11, wherein said outer casing has a face facing in the direction of said work plane, said face having one or more support cushioning elements.

20. An anti-constipation massage method using the anti-constipation device according to claim 11,
the method comprising the following steps:
a) positioning the device on a patient's belly such that the direction of translation of the support foot is positioned along a first working line, aligned along the longitudinal axis of a patient in a head-foot direction, at the first section of the colon,
b) positioning said support foot in a maximum extraction condition,
c) translating said support foot along the working line, in a head-foot direction,
d) positioning said support foot in a minimum extraction condition,
e) translating said support foot in the opposite direction with respect to step b)
f) positioning the device on the patient's belly such that the direction of translation of the support foot is positioned along a second working line, aligned along the front plane of a patient in a left-right direction, at the second colon section,
g) repeating steps b) to e);
the translation of said support foot being carried out in the right-left direction,
h) positioning the device on the patient's belly such that the direction of translation of the support foot is positioned along a third working line, aligned along the longitudinal axis of a patient in a head-foot direction, at the third colon section,
i) repeating steps b) to e);
the translation of said support foot being carried out in the head-foot direction.
